(19) United States
(12) Patent Application Publication
(10) Pub. No.: US 2026/0063083 A1
(43) Pub. Date: Mar. 5, 2026

(54) POSITION SENSING FOR MECHANICAL FUEL INJECTION SYSTEMS

(71) Applicant: Avco Corporation, Haslet, TX (US)

(72) Inventors: Michael Glynn Glucksman, Montgomery, PA (US); Robert William Straub, Milton, PA (US)

(21) Appl. No.: 19/319,297

(22) Filed: Sep. 4, 2025

Related U.S. Application Data
(60) Provisional application No. 63/690,537, filed on Sep. 4, 2024.

(51) Int. Cl. F02D 33/00; F02D 9/10

(52) U.S. Cl. CPC F02D 33/003; F02D 9/1065; F02D 2200/0404

(57) ABSTRACT

A mechanical fuel servo includes a servo body that defines an air conduit and a fuel path. The fuel servo further includes a throttle valve assembly coupled to the servo body. The throttle valve assembly includes a throttle shaft constructed and arranged to rotate responsive to control input to control airflow through the air conduit, and a throttle position sensor constructed and arranged to provide a first set of sensor signals that indicates an angular position of the throttle shaft. The fuel servo still further includes a fuel delivery assembly coupled to the servo body. The fuel delivery assembly includes a mixture valve shaft constructed and arranged to rotate responsive to other control input to control fuel flow through the fuel path, and a mixture valve position sensor constructed and arranged to provide a second set of sensor signals that indicates an angular position of the mixture valve shaft.

### CROSS-REFERENCE TO RELATED APPLICATIONS

This application claims the benefit of co-pending U.S. Provisional Application No. 63/690,537, filed Sep. 4, 2024, the contents and teachings of which are incorporated herein by reference in their entirety.

### BACKGROUND

Some aviation fuel injection systems include mechanical fuel servos that control fuel flow delivered to engines based on airflow through the mechanical fuel servos. These mechanical fuel servos have adjustable throttle valves and mixture valves to regulate airflow and air-fuel ratios, respectively.

During operation, a pilot (or autopilot) may operate controls that cause a mechanical fuel servo to establish an initial throttle valve position and an initial mixture valve position. These settings affect engine performance, such as manifold pressure, fuel flow, and engine speed. The pilot may adjust the throttle valve position and/or the mixture valve position until desired engine performance is met.

### SUMMARY

Unfortunately, the above-described mechanical fuel servos operate open-loop without providing direct feedback of throttle valve and mixture valve positions to a pilot or an avionics system. The lack of such feedback limits control over an aviation engine. For example, some auto-landing and auto-leaning operations may be configured to be performed under certain operating conditions. These operations may function less effectively without accurately knowing current throttle valve and mixture valve positions. Further, the lack of such knowledge may limit troubleshooting of aircraft components or accident reconstruction in the event of a malfunction. What is needed, therefore, is a way of providing direct feedback from a mechanical fuel servo.

The above need is addressed, at least in part, by a mechanical fuel servo equipped with position sensors mounted on a throttle shaft and a mixture shaft of the mechanical fuel servo. The sensors measure angular positions of the throttle shaft and mixture shaft, which may be provided as feedback to a pilot and/or an avionics system. Such feedback supports closed-loop control over the mechanical fuel servo. That is, adjustments to the throttle shaft and/or the mixture valve shaft may be directed based on the feedback of the angular positions of the throttle shaft and/or mixture shaft, e.g., to improve engine performance or perform certain operations. Further, such feedback may be recorded for troubleshooting, health monitoring, training, or other purposes.

Certain embodiments are directed to a mechanical fuel servo. The mechanical fuel servo includes a servo body that defines an air conduit and a fuel path. The mechanical fuel servo further includes a throttle valve assembly coupled to the servo body. The throttle valve assembly includes a throttle shaft constructed and arranged to rotate responsive to a first control input to control airflow through the air conduit, and a throttle position sensor constructed and arranged to provide a first set of sensor signals that indicates an angular position of the throttle shaft. The mechanical fuel servo still further includes a fuel delivery assembly coupled to the servo body. The fuel delivery assembly includes a mixture valve shaft constructed and arranged to rotate responsive to a second control input to control fuel flow through the fuel path, and a mixture valve position sensor constructed and arranged to provide a second set of sensor signals that indicates an angular position of the mixture valve shaft.

Other embodiments are directed to a fuel system for an aviation engine. The fuel system includes a mechanical fuel servo, such as the mechanical fuel servo described above. The fuel system further includes a set of discharge nozzles constructed and arranged to receive fuel from the mechanical fuel servo and provide fuel to a set of internal combustion chambers of the aviation engine. The fuel system further includes an electronic controller constructed and arranged to receive, from the throttle position sensor and the mixture valve position sensor, the first set of sensor signals and the second set of sensor signals as feedback. The electronic controller is further constructed and arranged to direct rotation of the throttle shaft and mixture valve shaft based on the feedback to provide closed-loop control of fuel flow through the fuel path to the set of discharge nozzles.

Still other embodiments are directed to a method of controlling fuel flow to an aviation engine. The method includes electronically rotating a throttle shaft and a mixture valve shaft of a mechanical fuel servo. The throttle shaft is constructed and arranged to control airflow through an air conduit defined by a servo body of the mechanical fuel servo, and the mixture valve shaft is constructed and arranged to control fuel flow through a fuel path defined by the servo body. The method further includes, in response to electronically rotating the throttle shaft and the mixture valve shaft, providing a first set of sensor signals and a second set of sensor signals to an electronic controller. The first set of sensor signals indicates an angular position of the throttle shaft, and the second set of sensor signals indicates an angular position of the mixture valve shaft. The method further includes, after providing the first set of sensor signals and the second set of sensor signals, further electronically rotating the mixture valve shaft based on instructions from the electronic controller providing closed-loop control of the mechanical fuel servo. The closed-loop control is based on the first set of sensor signals and the second set of sensor signals provided to the electronic control system.

The foregoing summary is presented for illustrative purposes to assist the reader in readily grasping example features presented herein; however, this summary is not intended to set forth required elements or to limit embodiments hereof in any way. One should appreciate that the above-described features can be combined in any manner that makes technological sense, and that all such combinations are intended to be disclosed herein, regardless of whether such combinations are identified explicitly or not.

### BRIEF DESCRIPTION OF THE SEVERAL VIEWS OF THE DRAWINGS

The foregoing and other features and advantages will be apparent from the following description of particular embodiments, as illustrated in the accompanying drawings, in which like reference characters refer to the same or similar parts throughout the different views. The drawings are not necessarily to scale, emphasis instead being placed upon illustrating the principles of various embodiments.

FIG. 1 is a perspective view of an example fuel servo in which embodiments of the improved technique can be practiced.

FIG. 2 is a perspective view of the example fuel servo of FIG. 1, in which embodiments of the improved technique can be practiced.

FIG. 3 is a bottom view of the example fuel servo of FIG. 1, in which embodiments of the improved technique can be practiced.

FIG. 4 is a cross-sectional view showing certain features of the example fuel servo of FIG. 1, in which embodiments of the improved technique can be practiced.

FIG. 5 is a cross-sectional view showing certain features of the example fuel servo of FIG. 1, in which embodiments of the improved technique can be practiced.

FIG. 6 is a block diagram of an example environment in which embodiments of the improved technique can be practiced.

FIG. 7 is a process diagram for providing closed-loop control of the example fuel servo of FIG. 1, in which embodiments of the improved technique can be practiced.

FIG. 8 is a flowchart showing an example method of controlling fuel flow to an aviation engine, according to one or more embodiments.

### DETAILED DESCRIPTION

Embodiments of the improved technique will now be described. One should appreciate that such embodiments are provided by way of example to illustrate certain features and principles but are not intended to be limiting.

An improved technique is directed to a mechanical fuel servo equipped with position sensors mounted on a throttle shaft and a mixture shaft of the mechanical fuel servo. The sensors measure angular positions of the throttle shaft and mixture shaft, which may be provided as feedback to a pilot and/or an avionics system. Such feedback supports closed-loop control over the mechanical fuel servo. That is, adjustments to the throttle shaft and/or the mixture valve shaft may be directed based on the feedback, e.g., to improve engine performance or perform certain operations. Further, the feedback may be recorded for troubleshooting, health monitoring, training, or other purposes.

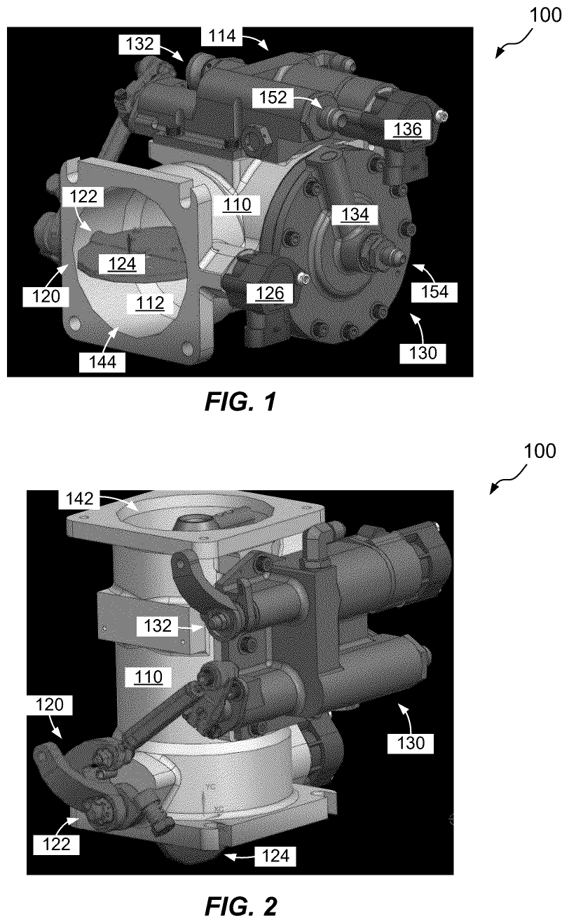

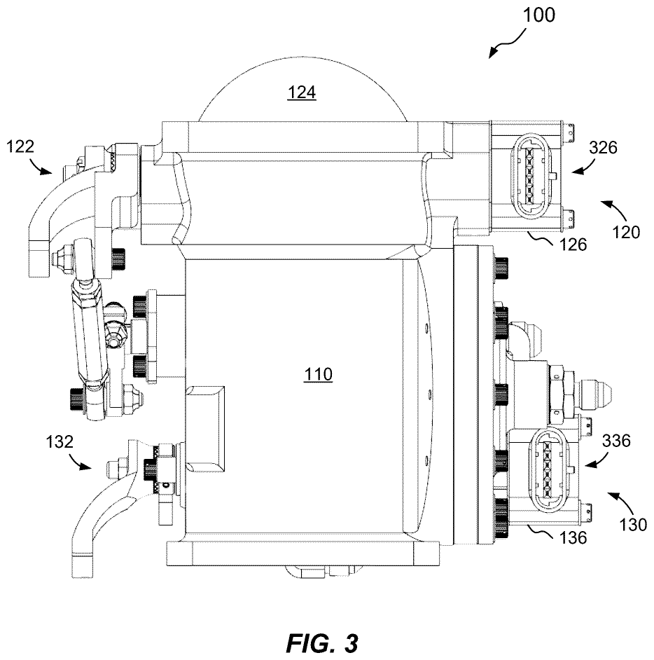

FIGS. 1 through 3 show various views of an example mechanical fuel servo 100 (also referred to herein as “fuel servo 100”) in which embodiments of the improved technique can be practiced. The fuel servo 100 is a device constructed and arranged to control fuel flow to an aviation engine. FIG. 1 shows a perspective view of the fuel servo 100. FIG. 2 shows another perspective view of the fuel servo 100. FIG. 3 shows a bottom plan view of the fuel servo 100. As shown, the example fuel servo 100 includes a servo body 110, a throttle valve assembly 120, and a fuel delivery assembly 130.

The servo body 110 defines an air conduit 112 and a fuel path 114 to route airflow and fuel flow, respectively. Air flows through the air conduit 112 from an air inlet 142, past the throttle valve assembly 120, and out an air outlet 144. In some examples, the air conduit 112 includes a venturi that creates an air pressure differential in the airflow through the air conduit 112. The fuel path 114 routes fuel (e.g., from a fuel source) from a fuel inlet 152, through the fuel delivery assembly 130, and out a fuel outlet 154. In some examples, the fuel outlet 154 leads to discharge nozzles (not shown) that discharge fuel into respective cylinder intake ports of an aviation engine. Although the term “body” is used herein, it should be understood that the servo body 110 may include various interconnected parts forming a singular unit.

The throttle assembly 120 is constructed and arranged to control airflow through the air conduit 112. To this end, the throttle assembly 120 includes a throttle shaft 122, a throttle plate 124, and a throttle position sensor 126. As shown, the throttle shaft 122 is mounted on the servo body 110 intersecting the air conduit 112. The throttle shaft 122 is constructed and arranged to rotate relative to the servo body 110 responsive to a first control input (e.g., action of an actuator). As further shown, the throttle plate 124 is mounted to the throttle shaft 122 and disposed at least partly within the air conduit 112. The throttle plate 124 is constructed and arranged to rotate with the throttle shaft 122 responsive to the first control input to control airflow through the air conduit 112. The throttle position sensor 126 is mounted on an end of the throttle shaft 122 and is constructed and arranged to measure an angular position of the throttle shaft 122. Example position sensors include Hall effect sensors, optical encoders, rotary potentiometers, rotational variable differential transformers, and so forth. As best shown in FIG. 3, the throttle position sensor 126 provides an interface 326 for connecting cables to the throttle position sensor 126, e.g. via a cable harness. In some examples, the cables include a power wire to transmit electrical power to the sensor, a ground wire, and one or more signal wires for transmitting sensor signals from the throttle position sensor 126.

The fuel delivery assembly 130 is constructed and arranged to control fuel flow through the fuel path 114. To this end, the fuel delivery assembly 130 includes a mixture valve shaft 132, a fuel regulator 134, and a mixture valve position sensor 136. The mixture valve shaft 132 is mounted on the servo body 110 at a portion of the fuel path 114 leading to the fuel regulator 134. The mixture valve shaft 132 is constructed and arranged to rotate relative to the servo body 110 responsive to a second control input (e.g., action of an actuator). In some examples, rotation of the mixture valve shaft 132 adjusts a fuel pressure differential of fuel entering the fuel regulator 134. The fuel regulator 134 is constructed and arranged to control fuel flow to the fuel outlet 154 based on the airflow through the air conduit 112 and the angular position of the mixture valve shaft 132. In some examples, the fuel regulator 134 may include one or more diaphragms that are displaced based on a fuel pressure differential in the fuel path 114 and/or an air pressure differential through the air conduit 112. In these examples, fuel flow may increase or decrease based on the displacement of the diaphragms. The mixture valve position sensor 136 is mounted to an end of the mixture valve shaft 132 and is constructed and arranged to measure an angular position of the mixture valve shaft 132. The mixture valve position sensor 136 may be a similar type of sensor as the throttle position sensor 126, though this is not required. As best shown in FIG. 3, the mixture valve position sensor 136 provides an interface 336 for connecting cables to the mixture valve position sensor 136, e.g., via a cable harness. The cables may be similar to those for the throttle position sensor 126 as discussed above.

During example operation, the throttle shaft 122 and the mixture valve shaft 132 are set to initial angular positions (e.g., as directed by a pilot or an autopilot). The throttle position sensor 126 and the mixture valve position sensor 136 measure these angular positions and provide sensor signals (e.g., output voltages) to an avionics system. In response to receiving the sensor signals, the avionics system may provide control inputs for adjusting the angular positions of the throttle shaft 122 and/or the mixture valve shaft 132 according to closed-loop control. For example, an autopilot may detect the current angular positions of the throttle shaft 122 and the mixture valve shaft 132 and direct changes to the angular positions to perform certain flight maneuvers (e.g., an auto-landing operation or an auto-leaning operation). Further, the sensor signals may be recorded for troubleshooting, health monitoring, training, or other purposes.

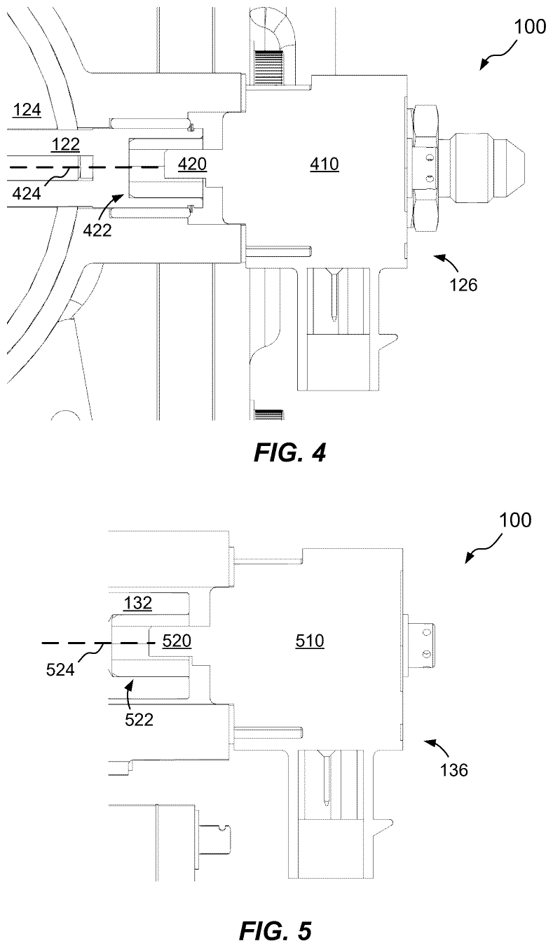

FIGS. 4 and 5 show various cross-sectional views of the fuel servo 100. FIG. 4 shows a cross-sectional view of the fuel servo 100 through the throttle shaft 122 and the throttle position sensor 126. FIG. 5 shows a cross-sectional view of the fuel servo 100 through the mixture valve shaft 132 and the mixture valve position sensor 136.

As shown in FIG. 4, the throttle position sensor 126 has a sensor body 410 and a D-shaped member 420 that is rotatable relative to the sensor body 410. The throttle position sensor 126 is constructed and arranged to provide output voltage based on the position of the D-shaped member 420 relative to the sensor body 410. The D-shaped member 420 pilots into a D-shaped slot 422 manufactured into the end of the throttle shaft 122. In this manner, the D-shaped member 420 rotates with the throttle shaft 122 along a shared axis of rotation 424.

Similarly, as shown in FIG. 5, the mixture valve position sensor 136 has a sensor body 510 and a D-shaped member 520 that is rotatable relative to the sensor body 510. The mixture valve position sensor 136 is constructed and arranged to provide output voltage based on the position of the D-shaped member 520 relative to the sensor body 510. The D-shaped member 520 pilots into a D-shaped slot 522 manufactured into the end of the mixture valve shaft 132. In this manner, the D-shaped member 520 rotates with the mixture valve shaft 132 along a shared axis of rotation 524.

During example operation, the throttle position sensor 126 provides an initial output voltage based on a current angular position of the D-shaped member 420 relative to the sensor body 410. As the D-shaped member 420 is mated with the throttle shaft 122, the angular position of the D-shaped member 420 changes relative to the sensor body 410 when the throttle shaft 122 is rotated (e.g., to control airflow through the air conduit 112). Based on this change in angular position, the throttle position sensor 126 provides a corresponding change in output voltage (e.g., from the initial output voltage to another output voltage). Similar operation may occur for the mixture valve position sensor 136 based on rotation of the mixture valve shaft 132. In this manner, the throttle position sensor 126 and the mixture valve position sensors 136 quickly and accurately indicate changes to the angular positions of the throttle shaft 122 and the mixture valve shaft 132, respectively.

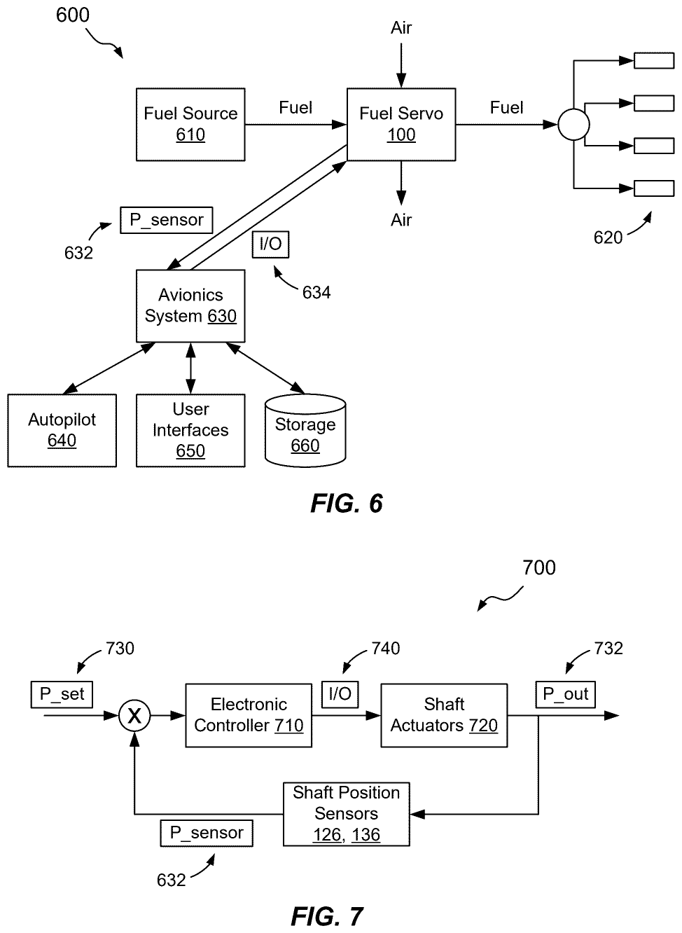

FIG. 6 shows an example environment 600 in which embodiments of the improved technique can be practiced. The example environment 600 may be provided on an aircraft to control fuel flow to an aviation engine. The example environment 600 includes the fuel servo 100, a fuel source 610, a set of discharge nozzles 620, an avionics system 630, an autopilot 640, one or more user interfaces 650, and storage 660.

The fuel source 610 (e.g., a fuel tank) is constructed and arranged to provide fuel to the fuel servo 100.

The discharge nozzles 620 are constructed and arranged to receive fuel from the fuel servo 100 and discharge the fuel to respective cylinder intake ports of an aviation engine. Additionally or alternatively, the discharge nozzles 620 may be part of another system that atomizes the fuel into airflow leading to the aviation engine, e.g., a carburetor. Further, although four discharge nozzles 620 are shown, it should be understood that more or fewer discharge nozzles 620 may be provided (e.g., one, two, six, and so forth).

The avionics system 630 is constructed and arranged to receive sensor signals 632 from the throttle position sensor 126 and the mixture valve sensor 136. In some examples, the avionics system 630 receives the sensor signals 632 as a series of digital signals from the throttle position sensor 126 and the mixture valve sensor 136 (e.g., in the case of optical encoders). Additionally or alternatively, the avionics system 630 may receive the sensor signals 632 as output voltage. In these examples, the avionics system 630 may convert (analog) output voltage values into digital signals to provide to the autopilot 640 and/or user interfaces 650. For example, the avionics system 630 may indicate the angular positions of the sensors as a percentage or a range (e.g., “open throttle” to “closed throttle,” “full rich” to “full lean,” so forth). Further, the sensor signals 632 (or their digital counterparts) may be recorded in the storage 660 (e.g., magnetic disk drives, electronic flash drives, and/or the like) for subsequent data analysis and/or investigation, future access by the autopilot 640, and so forth.

Further, the avionics system 630 is constructed and arranged to direct rotation of the throttle shaft 122 and/or the mixture valve shaft 132 to control fuel flow to the aviation engine. For example, the avionics system 630 may provide control inputs 634 for rotating of the throttle shaft 122 and/or the mixture valve shaft 132 based on instructions from the autopilot 640 or user interfaces 650. Additionally, in some examples, the avionics system 630 may provide recommendations for adjusting the throttle shaft 122 and/or mixture valve shaft 132 based on the sensor signals 632. These recommendations may be provided to the pilot through the user interfaces 650.

The autopilot 640 is constructed and arranged to receive information from the avionics system 630 and to provide instructions to the avionics system 630 for performing certain flight operations. Along these lines, the autopilot 640 may receive the sensor signals 632 from the avionics system 630. Based on the sensor signals 632, the autopilot 640 may instruct the avionics system 630 to rotate the throttle shaft 122 and/or mixture valve shaft 132 to certain angular positions to adjust fuel flow to the aviation engine. For example, the autopilot 640 may direct the avionics system 630 to perform an auto-landing operation in which the mixture valve shaft 132 is rotated to a “full rich” position and the throttle shaft 122 rotates to a “closed throttle” position. In another example, the autopilot may direct the avionics system 630 to perform an auto-leaning operation in which the mixture valve shaft 132 is rotated to an angular position that provides a leaner air-fuel ratio for increased fuel efficiency.

The user interfaces 650 are constructed and arranged to display certain information from the avionics system 630 and to transmit instructions to the avionics system 630. For example, the user interfaces 650 may include one or more displays that present current settings of the throttle valve assembly 120 and/or fuel delivery assembly 130, recommendations for changes from the avionics system 630, and so forth. Further, the user interfaces 650 may include input devices (e.g., push/pull cables or rods, buttons, knobs, and the like) for directing changes to the throttle valve assembly 120 and/or fuel delivery assembly 130. For example, the user interfaces 650 may include a first push/pull cable for controlling the angular position of the throttle shaft 122 and a second push/pull cable for controlling the angular position of the mixture valve 132.

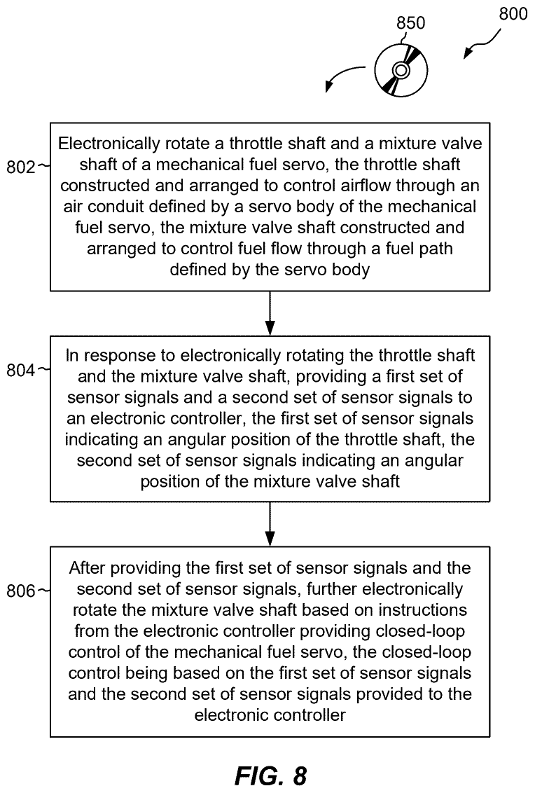

FIG. 7 shows a process diagram 700 for providing closed-loop control of the fuel servo 100 in accordance with certain embodiments. As described in greater detail below, an electronic controller 710 directs action of electronic actuators 720, which rotate the throttle shaft 122 and the mixture valve shaft 132. In some examples, the electronic controller 710 is provided as part of the avionics system 630 (FIG. 6).

During example operation, the electronic controller 710 receives setpoint positions (P_set) 730, indicating target angular positions of the throttle shaft 122 and mixture valve shaft 132. In some examples, the autopilot 640 or user interfaces 650 provide the setpoint positions 730 to the electronic controller 710. The electronic controller 710 further receives the sensor signals (P_sensor) 632 from the throttle position sensor 126 and the mixture valve position sensor 136, indicating current angular positions of the throttle shaft 122 and mixture valve shaft 132. Based on the setpoint positions 730 and sensor signals 632, the electronic controller 710 generates and transmits instructions 740 to one or more of the electronic actuators 720 for rotating the throttle shaft 122 and/or the mixture valve shaft 132. While the electronic actuators 720 rotate the throttle shaft 122 and/or the mixture valve shaft 132, the throttle position sensor 126 and the mixture valve position sensor 136 provide updated sensor signals 632 as feedback to the electronic controller 710, which may adjust the instructions 740 to the electronic actuators 720 accordingly. Operation may continue until the final angular positions (P_out) 732 (as sensed by the throttle position sensor 126 and the mixture valve position sensor 136) match the setpoint positions 730. Advantageously, such operation provides closed-loop control over the fuel servo 100.

FIG. 8 shows an example method 800 that may be carried out in connection with the environment 600. The method 800 is typically performed, for example, by the software, hardware, and/or firmware constructs shown in FIG. 6. The various acts of method 800 may be ordered in any suitable way. Accordingly, embodiments may be constructed in which acts are performed in orders different from that illustrated, which may include performing some acts simultaneously.

At 802, the electronic actuators 720 rotate the throttle shaft 122 and the mixture valve shaft 132 of the mechanical fuel servo 100. In some examples, the electronic actuators 720 rotate the throttle shaft 122 and the mixture valve 132 responsive to instructions from the electronic controller 710. The throttle shaft 122 is constructed and arranged to control airflow through the air conduit 112 defined by the servo body 110 of the mechanical fuel servo 100. The mixture valve shaft 132 is constructed and arranged to control fuel flow through the fuel path 114 defined by the servo body 110.

At 804 , in response to the throttle shaft 122 and the mixture valve shaft 132 being rotated, the throttle position sensor 126 and the mixture position sensor 136 provide a first set of sensor signals and a second set of sensor signals, respectively, as feedback to the electronic controller 710. The first set of sensor signals indicate an angular position of the throttle shaft 122, and the second set of sensor signals indicate an angular position of the mixture valve shaft 132.

At 806, after providing the first set of sensor signals and the second set of sensor signals, the electronic actuators 720 further rotate the mixture valve shaft 132 responsive to instructions from the electronic controller 710. In this manner, the electronic controller 710 provides closed-loop control of the mechanical fuel servo based on the feedback provided by the throttle position sensor 126 and the mixture position sensor 136.

Having described certain embodiments, numerous alternative embodiments or variations can be made. For example, as shown in FIG. 6, the user interfaces 650 provide instructions to the avionics system 630 for controlling the fuel servo 100. However, in alternative embodiments, the user interfaces 650 may provide control inputs directly to the fuel servo 100. For example, the user interfaces 650 may include push rods that directly control rotation of the throttle shaft 122 or the mixture valve shaft 132.

Further, although features have been shown and described with reference to particular embodiments hereof, such features may be included and hereby are included in any of the disclosed embodiments and their variants. Thus, it is understood that features disclosed in connection with any embodiment are included in any other embodiment.

Further still, the improvement or portions thereof may be embodied as a computer program product including one or more non-transient, computer-readable storage media, such as a magnetic disk, magnetic tape, compact disk, DVD, optical disk, flash drive, solid state drive, SD (Secure Digital) chip or device, Application Specific Integrated Circuit (ASIC), Field Programmable Gate Array (FPGA), and/or the like (shown by way of example as medium 850 in FIG. 8). Any number of computer-readable media may be used. The media may be encoded with instructions which, when executed on one or more computers or other processors, perform the process or processes described herein. Such media may be considered articles of manufacture or machines, and may be transportable from one machine to another.

As used throughout this document, the words “comprising,” “including,” “containing,” and “having” are intended to set forth certain items, steps, elements, or aspects of something in an open-ended fashion. Also, as used herein and unless a specific statement is made to the contrary, the word “set” means one or more of something. This is the case regardless of whether the phrase “set of” is followed by a singular or plural object and regardless of whether it is conjugated with a singular or plural verb. Also, a “set of” elements can describe fewer than all elements present. Thus, there may be additional elements of the same kind that are not part of the set. Further, ordinal expressions, such as “first,” “second,” “third,” and so on, may be used as adjectives herein for identification purposes. Unless specifically indicated, these ordinal expressions are not intended to imply any ordering or sequence. Thus, for example, a “second” event may take place before or after a “first” event, or even if no first event ever occurs. In addition, an identification herein of a particular element, feature, or act as being a “first” such element, feature, or act should not be construed as requiring that there must also be a “second” or other such element, feature or act. Rather, the “first” item may be the only one. Also, and unless specifically stated to the contrary, “based on” is intended to be nonexclusive. Thus, “based on” should be interpreted as meaning “based at least in part on” unless specifically indicated otherwise. Although certain embodiments are disclosed herein, it is understood that these are provided by way of example only and should not be construed as limiting.

Those skilled in the art will therefore understand that various changes in form and detail may be made to the embodiments disclosed herein without departing from the scope of the following claims.

What is claimed is:

1. A mechanical fuel servo for an aviation engine, comprising:
a servo body that defines an air conduit and a fuel path;
a throttle valve assembly coupled to the servo body, the throttle valve assembly including a throttle shaft constructed and arranged to rotate responsive to a first control input to control airflow through the air conduit, and a throttle position sensor constructed and arranged to provide a first set of sensor signals that indicates an angular position of the throttle shaft; and
a fuel delivery assembly coupled to the servo body, the fuel delivery assembly including a mixture valve shaft constructed and arranged to rotate responsive to a second control input to control fuel flow through the fuel path, and a mixture valve position sensor constructed and arranged to provide a second set of sensor signals that indicates an angular position of the mixture valve shaft.

2. The mechanical fuel servo of claim 1, wherein the throttle position sensor and the mixture valve position sensor are further constructed and arranged to provide the first set of sensor signals and the second set of sensor signals as feedback to an electronic controller, the electronic controller constructed and arranged to direct rotation of the throttle shaft and mixture valve shaft under closed-loop control based on the feedback.

3. The mechanical fuel servo of claim 2, further comprising:
a first electronic actuator and a second electronic actuator constructed and arranged to rotate the throttle shaft and the mixture valve shaft, respectively, responsive to receiving instructions from the electronic controller.

4. The mechanical fuel servo of claim 1, wherein mixture valve position sensor is further constructed and arranged to provide, as at least a portion of the second set of sensor signals, a first output voltage in response to detecting a first angular position of the mixture valve shaft and a second output voltage in response to detecting a second angular position of the mixture valve shaft, the first output voltage being different from the second output voltage.

5. The mechanical fuel servo of claim 1, wherein the throttle valve assembly further includes a throttle plate mounted to the throttle shaft and disposed at least partly within the air conduit, the throttle plate constructed and arranged to rotate with the throttle shaft responsive to the first control input to control the airflow through the air conduit.

6. The mechanical fuel servo of claim 1, wherein the fuel delivery assembly further includes a mechanical fuel regulator constructed and arranged to control the fuel flow based on the angular position of the mixture valve shaft and the airflow through the air conduit.

7. The mechanical fuel servo of claim 1, wherein the throttle position sensor and the mixture valve position sensor are mounted to the servo body adjacent to an end of the throttle shaft and an end of the mixture valve shaft, respectively.

8. The mechanical fuel servo of claim 7, wherein the mixture valve position sensor includes a rotatable member coupled to the end of the mixture valve shaft, the rotatable member constructed and arrange to rotate with the mixture valve shaft along a shared axis of rotation to detect the angular position of the mixture valve shaft.

9. A fuel system for an aviation engine, comprising:
a mechanical fuel servo that includes:
a servo body that defines an air conduit and a fuel path, and
at least one of:
(i) a throttle valve assembly coupled to the servo body, the throttle valve assembly including a throttle shaft constructed and arranged to rotate responsive to a first control input to control airflow through the air conduit, and a throttle position sensor constructed and arranged to provide a first set of sensor signals that indicates an angular position of the throttle shaft, or
(ii) a fuel delivery assembly coupled to the servo body, the fuel delivery assembly including a mixture valve shaft constructed and arranged to rotate responsive to a second control input to control fuel flow through the fuel path, and a mixture valve position sensor constructed and arranged to provide a second set of sensor signals that indicates an angular position of the mixture valve shaft;
a set of discharge nozzles constructed and arranged to receive fuel from the mechanical fuel servo and provide fuel to a set of internal combustion chambers of the aviation engine; and
an electronic controller constructed and arranged to:
receive a set of sensor signals as feedback from at least one of the throttle position sensor or the mixture valve position sensor, and
direct rotation of at least one of the throttle shaft or the mixture valve shaft based on the feedback to provide closed-loop control of fuel flow from the mechanical fuel servo to the set of discharge nozzles.

10. The fuel system of claim 9, further comprising:
an electronic actuator constructed and arranged to rotate at least one of the throttle shaft or the mixture valve shaft responsive to receiving instructions from the electronic controller.

11. The fuel system of claim 9,
wherein the mechanical fuel servo includes the fuel delivery assembly, and
wherein mixture valve position sensor is further constructed and arranged to provide, as at least a portion of the second set of sensor signals, a first output voltage in response to detecting a first angular position of the mixture valve shaft and a second output voltage in response to detecting a second angular position of the mixture valve shaft, the first output voltage being different from the second output voltage.

12. The fuel system of claim 9,
wherein the mechanical fuel servo includes the throttle assembly, and
wherein the throttle valve assembly further includes a throttle plate mounted to the throttle shaft and disposed at least partly within the air conduit, the throttle plate constructed and arranged to rotate with the throttle shaft responsive to the first control input to control the airflow through the air conduit.

13. The fuel system of claim 9,
wherein the mechanical fuel servo includes both the throttle assembly and the fuel delivery assembly, and
wherein the fuel delivery assembly further includes a mechanical fuel regulator constructed and arranged to control the fuel flow based on the angular position of the mixture valve shaft and the airflow through the air conduit.

14. The fuel system of claim 9,
wherein the mechanical fuel servo includes both the throttle assembly and the fuel delivery assembly, and
wherein the throttle position sensor and the mixture valve position sensor are mounted to the servo body adjacent to an end of the throttle shaft and an end of the mixture valve shaft, respectively.

15. The fuel system of claim 14,
wherein the mechanical fuel servo includes the fuel delivery assembly, and
wherein the mixture valve position sensor includes a rotatable member coupled to the end of the mixture valve shaft, the rotatable member constructed and arranged to rotate with the mixture valve shaft along a shared axis of rotation to detect the angular position of the mixture valve shaft.

16. A method of controlling fuel flow to an aviation engine, comprising:
electronically rotating a throttle shaft and a mixture valve shaft of a mechanical fuel servo, the throttle shaft constructed and arranged to control airflow through an air conduit defined by a servo body of the mechanical fuel servo, the mixture valve shaft constructed and arranged to control fuel flow through a fuel path defined by the servo body;
in response to electronically rotating the throttle shaft and the mixture valve shaft, providing a first set of sensor signals and a second set of sensor signals to an electronic controller, the first set of sensor signals indicating an angular position of the throttle shaft, the second set of sensor signals indicating an angular position of the mixture valve shaft; and
after providing the first set of sensor signals and the second set of sensor signals, further electronically rotating the mixture valve shaft based on instructions from the electronic controller providing closed-loop control of the mechanical fuel servo, the closed-loop control being based on the first set of sensor signals and the second set of sensor signals provided to the electronic controller.

17. The method of claim 16,
wherein electronically rotating the throttle shaft and the mixture valve shaft includes operating an electronic actuator coupled to the mixture valve shaft to rotate the mixture valve shaft to a first angular position, and
wherein further electronically rotating the mixture valve shaft includes operating the electronic actuator to rotate the mixture valve shaft to a second angular position that is different from the first angular position.
